(19) United States
(12) Patent Application Publication
(10) Pub. No.: US 2016/0216758 A1
(43) Pub. Date: Jul. 28, 2016

(54) PCI Express Device With Early Low Power State

(71) Applicant: Avago Technologies General IP (Singapore) Pte. Ltd., Singapore (SG)

(72) Inventors: Ramdas Prabhakar Kachare, San Jose, CA (US); Timothy Canepa, Milpitas, CA (US); Anup S. Tirumala, San Jose, CA (US); Kavitha Chaturvedula, Milpitas, CA (US)

(21) Appl. No.: 14/607,052

(22) Filed: Jan. 27, 2015

(51) Int. Cl. G06F 1/32; G06F 13/16

(52) U.S. Cl. CPC G06F 1/3296; G06F 13/1668; G06F 1/3225

(57) ABSTRACT

A storage device includes a storage medium, a transmit circuit, a receive circuit, power management means for turning off power to at least a portion of the transmit circuit when all host commands received by the receive circuit have been processed to retrieve data from the storage medium, and monitor means for monitoring host commands, and wherein the power management means does not turn off power to the monitor means when turning off power to other portions of the storage device.

### FIELD OF THE INVENTION

The present invention is related to systems and methods for power management for energy savings in PCI Express devices.

### BACKGROUND

Peripheral Component Interconnect Express (PCIe) is a high-speed electronic bus commonly used in computer systems for connecting peripheral devices such as storage devices to a motherboard. A PCIe bus is a highly optimized serial bus with point to point serial connections. Multiple devices can be connected to the bus using a switch to route communication, thus each device has dedicated connections avoiding the need to share connections among multiple devices. Physical connections in the PCIe bus are made by low-voltage differential pairs, with one differential pair used for a transmit portion of a lane and another differential pair used for a receive portion of a lane. Although the x1 lane, the smallest connection set in a PCIe bus, includes one differential pair for transmitting and one differential pair for receiving, additional lanes can be added in parallel in a link to a device to increase the rate of information transfer, although each independently controllable lane remains a serial connection.

Transaction requests are generated by a root complex or host on behalf of the processor on the motherboard. The transaction requests are transmitted via the PCIe bus to the peripheral device. The peripheral device processes the transaction requests, for example writing data or reading data and transmitting the requested data back to the host via the PCIe bus.

Energy conservation modes for peripheral devices are controlled by the host. Before a peripheral device enters its lowest power state, it requests permission from the host. There is no time upper bound specified to place a device into this state, thus, the time taken when a peripheral device has processed all pending host commands to when it is placed into its lowest power state can vary considerably.

### SUMMARY

Various embodiments of the present invention provide systems, apparatuses and methods for energy conservation in a Peripheral Component Interconnect Express (PCIe) device with an early low power state.

In some embodiments, a storage device includes a storage medium, a transmit circuit, a receive circuit, power management means for turning off power to at least a portion of the transmit circuit when all host commands received by the receive circuit have been processed to retrieve data from the storage medium, and monitor means for monitoring host commands, and wherein the power management means does not turn off power to the monitor means when turning off power to other portions of the storage device.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phrases do not necessarily refer to the same embodiment. This summary provides only a general outline of some embodiments of the invention. Additional embodiments are disclosed in the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals may be used throughout several drawings to refer to similar components. In the figures, like reference numerals are used throughout several figures to refer to similar components.

FIG. 1 depicts a block diagram of layers and power islands in a PCI Express peripheral device in accordance with some embodiments of the present invention;

FIG. 2 depicts a state diagram of a PCI Express peripheral device in accordance with some embodiments of the present invention; and

FIG. 3 is a flow diagram showing a method for energy conservation in a PCI Express peripheral device in accordance with some embodiments of the present invention.

### DETAILED DESCRIPTION OF THE INVENTION

The present invention is related to systems and methods for energy conservation in a Peripheral Component Interconnect Express (PCIe) device with an early low power state, also referred to herein as an as-soon-as-possible (ASAP) energy conservation mode. The peripheral device with the early low power state can be any electronic device with a PCI Express interface, such as, but not limited to, disk storage devices and solid state storage devices. The PCI Express specified software guided advanced low power states L1, L1.1/L1.2 etc. can be characterized as “as-late-as-possible” states, preventing peripheral devices from entering these low power states until approval is received from the host or root complex. The entry into the advanced low power states L1, L1.1/L1.2 etc. rely on standards-specified software/hardware schemes that are programmable timer based. The delay before the host allows a peripheral device to enter these advanced low power states can have a significant negative impact on energy consumption (power usage over time) in systems that have alternating active and idle behaviors. This is particularly significant for battery powered peripheral devices, which might be expected to operate for at least a day or more between battery recharge cycles. Although each delay before the host approves the low power state might be relatively short, when accumulated over a full day the cumulative delays can result in significantly more energy consumption.

In contrast, the early low power state disclosed herein is an as-soon-as-possible (ASAP) energy conservation mode in that the peripheral device is placed in a partially powered-down low power state autonomously, as soon as all host commands have been processed by the peripheral device, while the peripheral device is in the L0 active state and without obtaining or waiting for permission from the host to power down. The early low power state leverages the fact that peripheral devices such as disk storage devices and solid state storage devices have some leeway in choosing when to transmit, based on power and performance needs. Therefore the voltage to a large portion of the transmit section can be turned off when idle times are detected and restored with some relaxed delay without fundamentally impacting the operation or performance of a remotely paired host, usually on the same board. Similarly, most of the receive section can have its voltage turned off except for a small section that detects a remote host initiating a transfer. Both transmit and receive power reductions can be realized as soon as the device has finished processing host commands and is idle, and in advance of one of the PCI Express specified system software guided advanced low power states (L1 and L1.1/L1.2)

The ASAP power reduction begins when the PCIe link is still in the L0 active state, adding a low power pseudo sub-state L0s-SS to the L0 active state in which the PCI Express link is partially powered down, and providing particularly significant potential energy savings in systems that have alternating sleep and wake cycles.

The ASAP power reduction is enabled by power islands in PCI Express circuits that can be powered down in the low power sub-state L0s-SS. In some embodiments, power islands are formed by partitioning application-specific integrated circuits (ASICs) that enable the low power sub-state L0s-SS by limiting aggressive voltage restoration latencies (especially with respect to multi-threshold CMOS or MTCMOS technology) only to a subset of receive lane-specific logic. In some embodiments, a receive lane monitor or RX Lane Monitor is kept on in the low power sub-state L0s-SS and turned off only in the advanced low power states (L1 and L1.1/L1.2). The receive lane monitor can detect incoming activity on the PCI Express receive lane and restore power to some or all of the PCI Express circuits that were powered down in the low power sub-state L0s-SS. Alternatively, the RX Lanes may simply be coarsely clock gated in the low power sub-state L0s-SS and still yield an overall improvement in power.

The ASAP power reduction is supported by a staged wake-up mechanism that triggers on the receive lane monitor detecting an incoming PCI Express FTS Ordered Set when still in the L0s standby pseudo sub-state of active state L0.

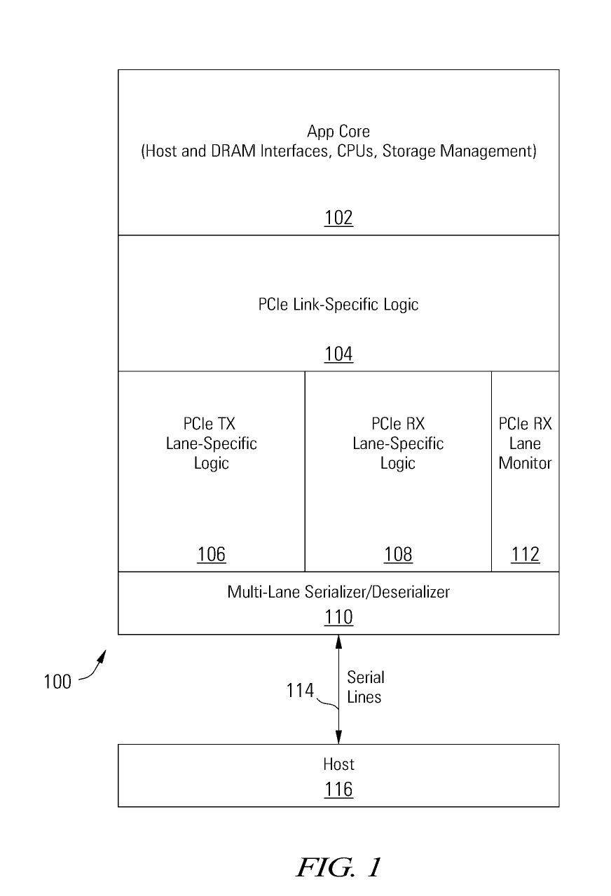

Turning now to FIG. 1, a block diagram illustrates the layers and power island partitioning in a PCI Express peripheral device 100 in accordance with some embodiments of the present invention. The peripheral device 100 or slave device is connected to a host 116 (also referred to as a root complex or master) by the low-voltage differential pair serial lines of a PCI Express bus 114. The PCI Express protocol is a layered protocol, permitting isolation between different functional areas. The various functional areas or layers to enable the low power sub-state L0s-SS can be divided into power islands in any suitable manner. The power islands shown in FIG. 1 are to be viewed as a non-limiting example. At an upper layer, an app core 102 in the peripheral device 100 includes for example host and dynamic random-access memory (DRAM) interfaces, central processing units (CPUs), and storage management circuits. The app core 102 processes requests from the host 116, for example to write data from the host 116 to a storage medium in the peripheral device 100 or to read data from the storage medium in the peripheral device 100 and transmit the data to the host 116. A lower level PCI Express link-specific logic layer 104 is portioned into a power island that is independent from the app core 102, enabling power to the app core 102 and the PCI Express link-specific logic layer 104 to be turned on and off separately. At yet a lower level, PCI Express transmit lane-specific logic 106 and PCI Express received lane-specific logic 108 are divided into separate power islands that can be powered on and off independently. A receive lane monitor 112 is provided to detect activity or the lack thereof on the PCI Express received lane-specific logic 108. Activity can be detected on the PCI Express received lane-specific logic 108 by the receive lane monitor 112, including using an idle detection circuit. Based upon the disclosure provided herein, one of ordinary skill in the art will recognize a variety of activity detection circuits that can be used in relation to different embodiments of the present invention. At yet a lower level, a multi-lane serializer/deserializer (SERDES) 110 translates data to be transmitted and received to serial packets that can be transmitted on the serial lines of the PCI Express bus 114, and as with other power islands, the power to multi-lane serializer/deserializer 110 can be independently controlled, allowing the multi-lane serializer/deserializer 110 to remain powered for example when other power islands are powered down.

Power can be turned on and off to power islands in the PCI Express circuits in any suitable manner, such as, but not limited to, gating off power supply lines (e.g., VDD), gating off clock signals, or in any other suitable manner. Power can be turned on and off to power islands either fully or partially in various embodiments of the present invention.

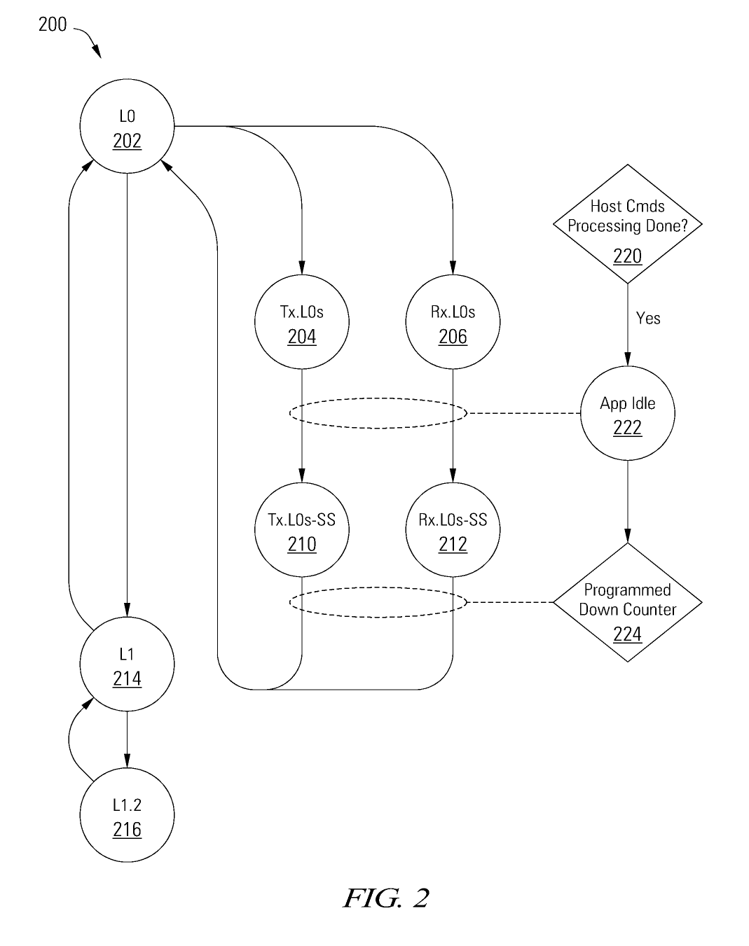

Turning now to FIG. 2, a state diagram 200 illustrates power state changes in a PCI Express peripheral device from the PCI Express end point perspective in accordance with some embodiments of the present invention. When in an L0 active state 202, the peripheral device is fully powered and operational, with the app core 102 processing host commands and with the transmit and receive lanes 106, 108 available for sending data on the PCI Express bus. In this state 202, all the power islands (the app core 102, PCI Express link-specific logic 104, transmit lane-specific logic 106, receive lane-specific logic 108, receive lane monitor 112 and multi-lane serializer/deserializer 110) are fully powered and active.

When the transmit lane of the PCI Express bus 114 is idle for a particular duration, the transmit lane-specific logic 106 and PCI Express link-specific logic 104 can be idled or partially powered down in a transmit L0s standby pseudo sub-state 204 of active state L0 202. Similarly, when the receive lane of the PCI Express bus 114 is idle for a particular duration, the receive lane-specific 108 can be idled or partially powered down in a receive L0s standby pseudo sub-state 206 of active state L0 202. The peripheral device can autonomously enter the transmit L0s standby sub-state 204 and/or receive L0s standby sub-state 206, without seeking or obtaining permission from the host.

When the app core 102 has completed processing of host commands 220, the app core 102 is in an app idle condition 222, and the peripheral device transitions to a low power sub-state L0s-SS of active state L0 202, represented in the state diagram 200 of FIG. 2 as a transmit low power sub-state L0s-SS 210 and a receive low power sub-state L0s-SS 212. In the transmit low power sub-state L0s-SS 210 and a receive low power sub-state L0s-SS 212, all but the receive lane monitor 112 and multi-lane serializer/deserializer 110 can be powered down, including the app core 102, PCI Express link-specific logic 104, transmit lane-specific logic 106, and receive lane-specific logic 108.

When a particular delay or time duration has elapsed in the app idle condition 222, the peripheral device can transmit a request to the host to enter the PCI Express specified software guided advanced low power states L1 214, L1.2 216, etc. In some embodiments, this time duration is measured using a programmed down counter 224 that establishes the duration of the app idle condition 222 before the peripheral device can request permission to enter the advanced low power states L1 214, L1.2 216. Notably, the elapsed time from the transmit L0s standby sub-state 204 and receive L0s standby sub-state 206 to the advanced low power state L1 214 can be very significant, ranging for example from tens of milliseconds to seconds, because the system software tends to avoid power cycle thrashing or repeated transitioning between an active state and a powered down energy conservation state. In other words, the programmed down counter 224 is typically initialized to a conservatively large number to prevent the peripheral device from entering the advanced low power state L1 214 too quickly, to reduce instances in which the motherboard receives an interrupt from a user or some other source and tries to wake up the PCI Express link with a Fast Training Sequence (FTS) Ordered Set command just as the peripheral device went to sleep, causing power cycle thrashing. When in the advanced low power state L1.2 216, the receive lane monitor 112 and multi-lane serializer/deserializer 110 can be powered down.

Thus, the addition of the transmit low power sub-state L0s-SS 210 and the receive low power sub-state L0s-SS 212 as an early low power state enable the peripheral device to autonomously power down various parts of the PCI Express circuits in the peripheral device, while in the active state (L0 202), without seeking or obtaining permission from the host and without entering the advanced low power states L1 214, L1.2 216. The PCI Express receive lane monitor 112 enables the peripheral device to be fully powered up from the transmit L0s standby sub-state 204 and receive L0s standby sub-state 206 when activity is detected on the receive lane of the PCI Express bus 114. This wake up from the early low power state to full power restoration can be achieved with very short latency for the receive lane in some embodiments in order to comply with the exit latency requirements for the receive L0s standby sub-state 206 in the PCI Express specification.

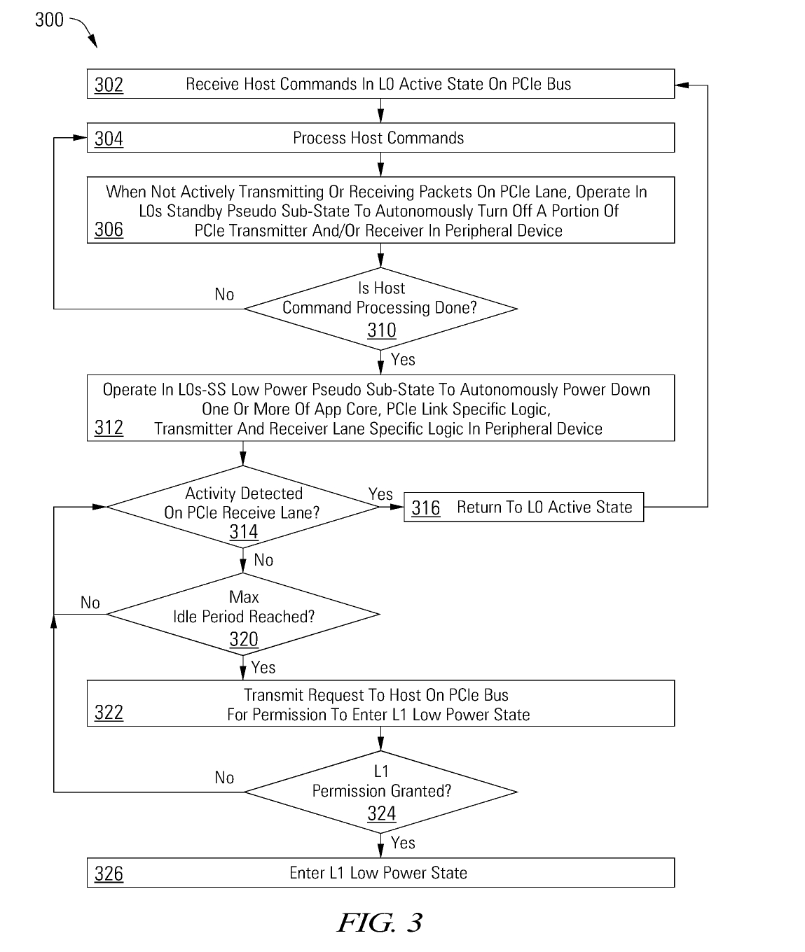

Turning now to FIG. 3, a flow diagram 300 illustrates an example method for energy conservation in a PCI Express peripheral device in accordance with some embodiments of the present invention. The peripheral device or slave device can be any type of electronic device with a PCI Express interface. The method of energy conservation is particularly effective in PCI Express storage devices with alternating active and idle behaviors, for which the delay between requests to a host device or master on the PCI Express bus to allow the peripheral device to enter an advanced low power state or L1 state become cumulatively significant in energy consumption and/or thermal effects.

Following flow diagram 300, host commands are received by the peripheral device via the PCI Express bus. (Block 302) Such host commands can be any request for the peripheral device to take some action, such as, but not limited to, read and write commands. The host commands are received by the peripheral device on the PCI Express bus while in an L0 active state. In other words, the method begins in some embodiments and some instances when the peripheral device is active and fully powered. Although the PCI Express circuitry of the peripheral device can be divided into power islands in any suitable manner, in some embodiments, the power islands of the peripheral device include an app core, PCI Express link-specific logic, transmit lane-specific logic, receive lane-specific logic, receive lane monitor and multi-lane serializer/deserializer, all of which are fully powered in the L0 active state. In some cases, the receipt and processing of the host commands causes the peripheral device to enter the L0 active state from some other, lower power state.

The peripheral device processes the host commands. (Block 304) In some embodiments, the host commands are processed in an app core of the peripheral device, including for example host and dynamic random-access memory (DRAM) interfaces, central processing units (CPUs), and storage management circuits. When not actively transmitting or receiving packets in transmit or receive lanes of the PCI Express bus, the peripheral device operates in a L0s standby pseudo sub-state to autonomously turn off the PCI Express transmitter and/or receiver in the peripheral device. (Block 306) The entry into the L0s standby sub-state to power down the PCI Express transmitter and/or receiver in the peripheral device can be performed without requesting permission from the host. In some embodiments, the powering down is relatively minimal, for example gating off clock signals in the PCI Express transmitter and/or receiver lane specific logic.

A determination is made as to whether host command processing is complete in the app core. (Block 310) Host command processing is complete when there are no pending host commands in the app core of the peripheral device awaiting processing. If the host command processing is complete, and the app core is in an idle condition, the peripheral device enters an L0s-SS low power pseudo sub-state to autonomously power down one or more of app core, PCI Express link specific logic, transmitter and receiver lane specific logic in the peripheral device. (Block 312) Notably, the L0s-SS low power pseudo sub-state is a sub-state of the active state L0. In other words, the powering down of various parts of the PCI Express circuitry in the peripheral device based on the app idle condition is performed while in the active power state. Furthermore, the entry into the L0s-SS low power pseudo sub-state is performed without seeking or obtaining permission from the host.

The PCI Express receive lane is monitored for activity while in the L0s-SS low power pseudo sub-state. (Block 314) If activity is detected on the PCI Express receive lane, the PCI Express circuitry in the peripheral device is powered up or woken up. (Block 316) Notably, the restoration of power to the PCI Express receive lane specific logic is performed within the time specified by the PCI Express specification, avoiding excessive exit latency. For peripheral devices such as disk storage devices and solid state storage devices with more leeway in choosing when to transmit, the restoration of power to the transmit lane-specific logic and PCI Express link-specific logic can be performed more slowly in some embodiments if desired.

A determination is made as to whether a max app idle period has been reached in the peripheral device. (Block 320) This can be performed by a programmable down counter or other means in the peripheral device for determining when the app core has been idle in the peripheral device for a maximum idle period or another predetermined amount of time. The maximum idle period can be set to any desired value, although it is typically set to a conservatively long period that prevents power cycle thrashing or switching back and forth between active and low power states in the peripheral device.

If the maximum idle period is reached with the app core remaining idle, the peripheral device transmits a request to the host on the PCI Express bus for permission to enter the L1 advanced low power state. (Block 322) A limit can be placed on the frequency of requests by the peripheral device for permission to enter the L1 advanced low power state in some embodiments. If the host grants the peripheral device permission (block 324), the peripheral device enters the L1 advanced low power state. (Block 326) In some embodiments, the receive lane monitor and multi-lane serializer/deserializer in the peripheral device are powered down when in the L1.2 sub-state of the L1 advanced low power state.

As a consequence of conservatively long periods established by the programmable down counter before the peripheral device can request host permission to enter the L1 advanced low power state, the L1 advanced low power state does not provide particularly aggressive energy conservation for peripheral devices with alternating active and idle behaviors. The L0s-SS early low power pseudo sub-state compensates for the conservative entry into the L1 advanced low power state, enabling the peripheral device to autonomously conserve energy starting while the peripheral device is in the L0 active state, without seeking or obtaining host permission. Both transmit and receive power reductions can be realized as soon as the app core in the peripheral device has finished processing host commands and is idle, and in advance of one of the PCI Express specified system software guided advanced low power states (L1 and L1.1/L1.2). The PCI Express circuits of the peripheral device are partitioned into power islands that support the L0s-SS early low power pseudo sub-states, limiting aggressive voltage restoration latencies only to a subset of the PCI Express receive lane specific logic. A PCI Express receive lane monitor is kept on in the L0s-SS early low power pseudo sub-states, being turned off only when the peripheral device has reached the L1.2 advanced low power state. This enables the PCI Express receive lane monitor to detect activity such as a Fast Training Sequence (FTS) Ordered Set on the PCI Express receive lane and to restore power to the PCI Express receive lane specific logic within exit latencies specified by the PCI Express specification.

In conclusion, the present invention provides novel systems, apparatuses and methods for energy conservation in a Peripheral Component Interconnect Express (PCIe) device with an early low power state. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A storage device comprising:
a storage medium;
a transmit circuit;
a receive circuit;
power management means for turning off power to at least a portion of the transmit circuit when all host commands received by the receive circuit have been processed; and
monitor means for monitoring host commands, and wherein the power management means does not turn off power to the monitor means when turning off power to other portions of the storage device.

2. The storage device of claim 1, wherein the storage device comprises a Peripheral Component Interconnect Express (PCIe) storage device.

3. The storage device of claim 1, wherein said power management means is configured to autonomously power down PCIe circuits in the storage device while in an L0 active state without obtaining host permission.

4. The storage device of claim 1, wherein the power management means turns off power as soon as the storage device is in an idle state and while a link to the receive circuit is still in an active state.

5. The storage device of claim 1, wherein the storage device comprises a Solid State Drive.

6. The storage device of claim 1, wherein the storage device comprises a hard disk drive.

7. The storage device of claim 1, wherein the power management means also turns off power to at least a portion of the receive circuit when all host commands received by the receive circuit have been processed to retrieve data from the storage medium.

8. The storage device of claim 1, wherein the power management means turns on the power when a monitor circuit in the receive circuit detects an incoming Peripheral Component Interconnect Express message.

9. The storage device of claim 1, wherein the power management means turns on the power when a monitor circuit in the receive circuit detects an incoming Peripheral Component Interconnect Express Fast Training Set Ordered Set when still in an L0 state.

10. The storage device of claim 1, further comprising a serializer/deserializer circuit, wherein the serializer/deserializer circuit remains powered when the power management means turns off power to other portions of the receive circuit.

11. The storage device of claim 1, further comprising an app core and Peripheral Component Interconnect Express link specific logic, wherein the power management means is operable to turn off power to the app core and Peripheral Component Interconnect Express link specific logic when all host commands received by the receive circuit have been processed and while the storage device remains in an active power state.

12. A method for conserving energy in a PCIe peripheral device, comprising:
receiving host commands in the peripheral device via a PCIe bus;
processing host commands in the peripheral device; and
when all host commands have been processed in the peripheral device, autonomously powering down at least some PCIe circuits in the peripheral device while in an active state without obtaining host permission.

13. The method of claim 12, further comprising:
monitoring a receive lane in the PCIe bus for activity; and
restoring power to said at least some PCIe circuits.

14. The method of claim 13, wherein said activity comprises a Fast Training Sequence Ordered Set.

15. The method of claim 13, said restoring power being completed for a PCIe receive lane within PCIe specification latency requirements.

16. The method of claim 12, wherein said active state comprises a PCIe L0 state.

17. The method of claim 12, wherein said autonomously powering down at least some PCIe circuits in the peripheral device while in the active state without obtaining host permission comprises entering a sub-state of the active state.

18. The method of claim 17, further comprising transmitting a request to enter a PCIe L1 state after a programmed counter reaches a predetermined value while in said sub-state of the active state.

19. An electronic system comprising:
a Peripheral Component Interconnect Express bus;
a host device; and
a slave device connected to the host device through the Peripheral Component Interconnect Express bus, wherein the slave device comprises an app core and Peripheral Component Interconnect Express link specific logic, and wherein the slave device is configured to power down the app core and the Peripheral Component Interconnect Express link specific logic without obtaining permission from the host device when it has no pending commands from the host device to process, and while remaining in an L0 active state.

20. The electronic system of claim 19, wherein the slave device comprises a monitor circuit operable to detect an incoming Fast Training Sequence Ordered Set from the host device on a receive lane in the Peripheral Component Interconnect Express bus to trigger restoration of power to the app core and the Peripheral Component Interconnect Express link.
